(19) United States
(12) Patent Application Publication
(10) Pub. No.: US 2007/0251139 A1
(43) Pub. Date: Nov. 1, 2007

(54) Pest control device and associated method

(76) Inventors: Samuel M. Creeger, Pittsburgh, PA (US); Uri K. Fakiro, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/370,963

(22) Filed: Mar. 8, 2006

(51) Int. Cl. A01M 25/00; A01M 1/20

(52) U.S. Cl. 43/131

(57) ABSTRACT

A pest control device includes an exposure chamber that is easily accessible to target pests, but which resists entry of larger, non-targeted organisms, for example, household pets or children. The exposure chamber includes an interior surface that is covered by a perforated membrane. A poison may be disposed between the interior surface and the perforated membrane. The poison includes a microencapsulated interior active ingredient mixed within a carrier substance structured to retain the poison between the interior surface and the membrane, and to adhere to the exterior surface of a pest until the pest ingests the poison during grooming. Upon ingestion of the microencapsulated poison during grooming, the microcapsules decompose thereby releasing the active ingredient within the pest.

### BACKGROUND OF THE INVENTION

1. Field of the Invention

The present invention relates to pest control. More specifically, the invention provides an apparatus and method for controlling pests such as rodents and insects that causes the poison to be picked up by an exterior surface of the target pests, where it will be ingested during grooming, while avoiding exposure to the poison by non-targeted organisms.

2. Description of the Related Art

In addition to other pests, such as ants, roaches, bees, hornets, spiders, millipedes, and other arthropods, bats, groundhogs, raccoons and other mammals, rats and mice are particularly troublesome. Rats and mice are both rodents. The term “rodent” means “to gnaw” which is an apt description of rats and mice which have the habit of gnawing on objects without the intention of using the object for food. About 2% of the day of Norway rats is spent on gnawing. Rats and mice are also known as “commensal rodents” which literally means “sharing the table”. This is also a very appropriate description of rats and mice in that wherever humans have established their homes and communities, rats and mice soon invade and take advantage of the food and shelter stored in the homes and communities of their human benefactors.

Rats such as the Norway rat (Rattus norvegicus) and mice such as the house mouse (Mus musculus) spread diseases such as viral, bacterial, fungal, protozoan and worm diseases, to humans and other animals, including animals that provide meat, milk, fiber, and other commodities. Norway rats and house mice also cause tremendous amounts of damage to growing food and stored food supplies. Not only is the food damaged by the direct eating of the food, but the food becomes unusable due to contamination by rodent droppings, urine, and hair and it becomes unusable due to the packaging becoming punctured and ripped open by the Norway rat and house mouse. Norway rats also kill and eat poultry, eat eggs, and Norway rats and house mice eat grain feed intended for livestock. In addition, the gnawing habits of rodents damage furniture and home furnishings, clothing and textiles, buildings and building materials such as electrical wire, plumbing and insulation. Also, the burrowing habits of rodents result in subsidence and damage to roadways, railroad lines, sidewalks and building foundations.

In the United States, rats consume $19 billion worth of food a year (D. Pimentel, R. Zuniga, D. Morrison. Update on the Environmental and Economic Costs Associate with Alien-Invasive Species in the United States. Ecological Economics. Elsevier Press. In press [2004]) and they contaminate 10 times as much food as they eat with their droppings, urine and shed hair (P. G. Koehler, W. H. Kern, Jr. Rat and Mouse Control [document ENY-224]. University of Florida, Inst. of Food and Agric. Sci. June 2005). Their habits of gnawing into building materials, burrowing under buildings, roads and infrastructure, and spreading 55 different diseases cause additional damage to society.

Although world expenditures for chemical rodenticides in 1999 were about $1 billion (not including expenditures on rodent traps and labor) (U.S. EPA), rodent damage to the world food supply is substantial. Every year, rats in Asia consume food crops that could feed 200 million people for an entire year (Singleton, 2003). In Indonesia, rodents cause an average of at least 15% annual losses of rice (Geddes, 1992). In Tanzania, rodents cause an annual loss of 5-15% of the maize crop. In parts of South America, rodent damage to crops varies between 5-90% of total production (Rodriquez, 1993).

While the remainder of this description will, for convenience of disclosure, focus on the Norway rat, many of the traits described apply to other rodents such as the house mouse.

Norway rats have a territory of about 50-650 yards, where the smaller territorial range is in urban locations and the larger territorial range is in rural locations. Norway rats are most active during nighttime hours with peaks in activity at 1-2 hours after sunset and at 1-2 hours before sunrise. Norway rats also exhibit negative geotaxis, which is the tendency to move downwards as opposed to moving upwards. This explains why rats prefer to burrow downward in soil and are frequently found below street level in sewers.

Norway rats are excellent climbers. They can climb up or down any rough, vertical surface, and they can climb up or down the inside or outside of pipes about 1-4 inches in diameter, Norway rats can jump vertically several times their length and can jump horizontally even further. They can also walk across wires to gain entry from one building to another.

Norway rats, frequently found nesting in river banks, in canals and in and around sewer systems, are capable swimmers and can be considered semi-aquatic. In commercial fish farm operations, Norway rats jump into water to catch fish. Norway rats have also entered homes and buildings through toilets by swimming through the water trap at the base of the toilet.

Norway rats become sexually mature at 8-12 weeks of age. Sexually-mature, female, Norway rats ovulate every 4-6 days. Sexually-mature, male, Norway rates are attracted to the ovulating sexually-mature, female, Norway rat by an odor emitted by the sexually-mature female, Norway rat. Mating takes place and a litter of an average of 6-12 pups is born 20-23 days later. Female Norway rats have 3-7 litters per year. On the average 44-45 Norway rat pups survive beyond weaning per year per female Norway rat. The life span of Norway rats is about 12-18 months.

Norway rats groom themselves frequently. Up to 20% of the waking time of Norway rats is spent on grooming themselves.

Norway rats have a high sensitivity to light, but due to poor visual acuity do not see objects clearly. Blind Norway rats behave and do as well as sighted Norway rats indicating the minimal reliance of Norway rats on the sense of sight. Although Norway rats have poor eyesight they nevertheless are able to rapidly and skillfully sense and negotiate through their environment by the senses of touch, taste, hearing, smell and an ability called kinesthetics. More information on these senses and abilities are provided hereinafter.

As Norway rats are most active at night during darkness, they rely heavily on the sense of touch to move, maneuver and orient themselves in their environment. Norway rats prefer to move about while having their whiskers and guard hairs (long, sensitive, tactile hairs interspersed among the hairs of their fur) in contact with objects. This apparently gives the Norway rat a sense of security in knowing that they are not subject to attack from the side on which they are in contact with an object.

Norway rats have a well-developed sense of taste. Not only do they select fresh food over spoiled food, but they can detect minute quantities (0.25 parts per million) of bitter or objectionable substances in food. This highly developed sense of taste is often the cause of bait refusal by Norway rats.

Norway rats have a well-developed sense of hearing and can locate sources of sounds in darkness to within 6 inches. They can detect all the frequencies humans can (the human upper limit is 20 kHz) plus frequencies up to 100 kHz. There is evidence that rats communicate with one another at frequencies above 20 kHz and may use ultrasounds in echo-location like bats. The Norway rat's keen sense of hearing also provides warning to the animal of nearby enemies or danger.

Norway rats also have a well-developed sense of smell. The sense of smell of Norway rats attracts them to a food source, allows them to distinguish between individual rats and allows males to find ovulating females. Rats leave odor trails which are followed by other rats looking for food or for mating. Rats suddenly stop moving when they detect cat odor.

Norway rats also have a sense known as kinesthetics, which is the ability of the animal to learn and memorize its surroundings after repeated contact and repeated sequences of muscle movements. Because of kinesthetics, Norway rats have well-established runways leading from their burrows to their food supplies.

Norway rats are neophobic, meaning they avoid new objects or new food placed in their surroundings. If rats are accustomed to eating a particular food and a better food is offered, they will avoid the better food because of neophobism. Rats in the laboratory have been seen to avoid the same food if it is only placed in an identical but different feeding dish from which they were accustomed to eat. In one experiment, rats lost over 10% of their body weight over two days rather than feed from the identical but different feeding tray. Neophobia is one of the reasons of bait rejection by rats.

There are several control methods for delivering pest control agents to Norway rats. One method involves the use of a food bait which is mixed with a rodenticide. Although there are effective rodenticide bait products available, they have limitations. Some of the limitations are: (1) The neophobia of Norway rats has to be overcome. This can be even more difficult if the Norway rats have an adequate supply of a competing food. This can result in many weeks passing before the Norway rats take the poison bait. (2) The poison baits cannot be liberally spread around where rats are active because of the potential for contact by children, pets and other non-target organisms. The poison baits must be placed in well-defined, specific locations inaccessible to children, pets and other non-target organisms, or in secure, child-resistant, pet-proof bait boxes, or directly in the rat burrows.

(3) Baits placed in sewer systems rapidly decompose due to the high moisture and bacterial environment of the sewer and become unpalatable to the rat.

(4) Baits absorb odors from their surroundings, including tobacco smoke and gasoline, making the bait unpalatable to the rat.

(5) A large investment in labor is needed to continually replace the old bait, spoiled bait and missing bait with fresh bait.

(6) A bait box can hold enough poison bait to kill several dozen rats, but just a few rats may eat all the bait or remove all the bait and hoard it in their burrows for later consumption. This rat behavior prevents other rats from consuming the bait.

(7) Since the amount of rodenticide in rodent bait is a very low percentage (typically 0.025-0.05%) so as to maintain the palatability of the bait to the rodent, the rodent must consume a large amount of the bait to acquire a toxic dose of rodenticide.

Another effective method of rat control involves the use of tracking powder, which is an odor-free, poisonous powder such as zinc phosphide, that is dusted directly inside enclosures or along the runways or in the wall voids where rats are known to frequent. The rats run through the powder which adheres to the paws and fur of the rat. When the rat grooms itself, it ingests the zinc phosphide powder which then reacts with the moisture and aqueous acid in the digestive system of the rat forming phosgene gas, a poisonous gas that kills the rat. However, zinc phosphide cannot be used where contact by children or non-pest organisms is possible. Also, zinc phosphide and other tracking powders cannot be used in moist environments such as rat burrows and sewers because the moisture will cause caking of the powder which reduces or removes the ability of the powder to adhere to the paws and fur of the rat. Also, moisture in rat burrows, sewers and the environment can result in the decomposition of the active ingredient in the tracking powder before it is contacted by the pest rodent.

Other examples of pest control include U.S. Pat. No. 4,375,732, issued to E. Waast, disclosing a device for combating rodents. The device includes a tunnel having a container attached thereto. The container may be filled with a powdered bait which forms a sloping pile partially obstructing the tunnel. The rodent passing through the tunnel may either eat the bait, or come in contact with the bait, causing the rodent's fur to be covered with the bait. The rodent then ingests the bait during grooming. The use of a food type bait carries the disadvantages discussed hereinbefore.

U.S. Pat. No. 4,753,032 issued to D.A. Sherman discloses a poison delivery system for rodents. The delivery system includes a tube structure having a solid baffle wall therein, with the wall defining an opening containing a wick. The wick is structured to permit a rat to pass therethrough, and is impregnated with a poison that coats the rat's fur as it passes therethrough. The rat ingests the poison as it cleans itself. The tube is structured so that it would be difficult for a child to insert his hand sufficiently deep to contact the poison. The patent provides little description of the wick itself. The patent further fails to disclose any means of resisting degradation of the active ingredient of the poison due to time and environmental factors, or any carrier within the poison to cause it to adhere to a target pest.

U.S. Pat. No. 5,182,879, issued to J. I. Hopkins, discloses a crawling insect trap. The trap includes a tube having a cloth felt wick therein. The wick is permeated by a bioactive compound that may be capable of killing the target insect or resisting reproduction of the insect. The bioactive agent is ingested by the target insect during grooming. The exterior of the tube may be coated with a bitter tasting, non-toxic agent to resist contact with the tube by children or non-target animals. This patent does not disclose any means of resisting degradation of the active ingredient of the poison, or any carrier within the poison for causing it to adhere to the target pest.

U.S. Pat. No. 5,979,108, issued to A. J. Adams, discloses a pest control device having a sloping ceiling with a pesticide disposed thereon, so that when an insect enters the device, it comes in contact with the ceiling and receives a topical dose of pesticide. The ceiling is preferably deformable or movable on contact by the target pest, and maybe, for example, compressible padding material, or a light, deformable, movable structure that is suspended from the ceiling. The treated interior ceiling may be removable to enable it to be replenished with pest control agent. The pesticide may be in the form of a grease, paste, gel, or cream, for example. This device, therefore, relies entirely on the adhesion of the pesticide to the ceiling, and provides no physical structure to retain the pesticide against the ceiling.

U.S. Pat. No. 6,662,491, issued to R. A. Flinn et al., discloses an insecticide dispenser. The dispenser contains a granular insecticide that dissolves upon contact with water, and is intended for water treatments. Dusted granular carriers include No. 5 red flint sand, gypsum, and corn cob granulars.

U.S. Pat. No. 6,792,713, issued to E. J. Snell on Sep. 21, 2004, discloses a replenishable pest control apparatus having a housing containing a replenishable attractant and a replenishable pesticide.

As noted in the forgoing description, there remains a very real and substantial need for a method and apparatus of effectively and efficiently delivering a rodent control agent to Norway rats and other pests, such as house mice, especially in humid environments such as sewers and outdoor rat burrows, and in a manner that will have minimal adverse impact on humans and non-target organisms, will not require the use of an edible food bait and will require less maintenance by pest control staff than existing methods of delivery of rodent control agents.

### SUMMARY OF THE INVENTION

These and other needs are met by the pest control apparatus and the method of the present invention. The apparatus includes an exposure chamber having a flexible perforated membrane covering all or a portion of its interior surface. A poison is retained between the flexible membrane and the interior surface of the container.

For the purpose of this description, a pest is defined as any undesired animal or insect. A target pest or targeted pest is a specific pest for which the apparatus is designed. A non-targeted organism is any human being or other animal in the vicinity of the apparatus, with respect to which the object of the invention is to avoid exposing to the poison, and in particular includes children and household pets. The exterior surface of the target pest may include either the fur of the targeted animal, or the exoskeleton of a targeted insect.

The poison preferably includes an active ingredient surrounded by capsules that are structured to release the active ingredient upon being ingested by a pest. The microencapsulated poison is mixed with a carrier that retains the capsules between the membrane and the interior surface of the exposure chamber, and which may also cause the capsules to adhere to the fur of a rodent, or the exterior surface of another targeted pest.

A rodent or other targeted pest passing through the apparatus will push against the perforated membrane as it passes through the exposure chamber, thereby forcing the poison through the perforations onto the exterior of the rodent or other targeted pest. As the rodent or other targeted pest grooms itself, it will ingest the poison.

It is therefore an object of the invention to provide a poison that resists environmental degradation for killing targeted pests.

It is another object of the invention to provide a poison for killing targeted pests that is not dependent on a food type bait that is subject to spoilage or hoarding by targeted pests, and which must be replaced frequently.

It is a further object of the invention to provide a microencapsulated poison for targeted pests, having capsules that release the active ingredient of the poison upon ingestion via grooming by a targeted pest.

It is another object of the invention to provide an apparatus that takes advantage of a targeted pest's natural inclination to seek harborage, while also reducing contact with the poison by non-targeted organisms such as children or household pets.

It is a further object of the invention to provide a pest control apparatus that is more cost efficient than other pest control devices.

These and other objects of the invention will become more apparent through the following description and drawings.

### BRIEF DESCRIPTION OF THE DRAWINGS

FIG. 1 is a partially cutaway isometric view of one embodiment of the pest control apparatus according to the present invention.

FIG. 2 is a partially cutaway isometric view of another embodiment of a pest control apparatus of the present invention.

FIG. 3 is a cross-sectional view of a microsphere containing the active ingredient of a poison according to the present invention.

FIG. 4 shows a plan view of a chamber having internal baffles.

FIG. 5 is an elevational view in sections showing a multiple vertically stacked chamber having two subunits.

Like reference characters denote like elements throughout the drawings.

### DESCRIPTION OF THE PREFERRED EMBODIMENTS

The present invention provides a pest control apparatus including both an improved poison dispensing apparatus and an improved means of packaging and delivering a poison to a pest.

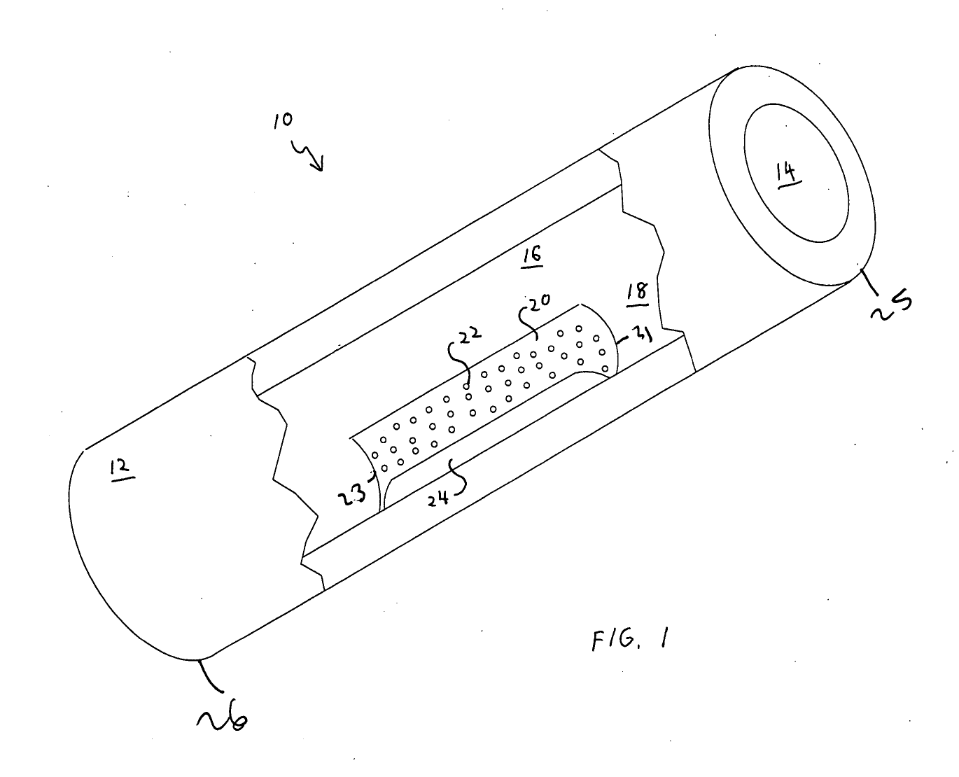

Referring to FIG. 1, one embodiment of the poison dispensing apparatus is illustrated. Apparatus 10 includes a tubular housing 12 which in the illustrated embodiment is cylindrical, but which may have any other tubular configuration, such as rectangular or triangular, for example. The housing 12 includes a pair of end openings 14, with one opening 14 disposed at each end of the housing. Other openings may also be defined within the housing 12, if desired. The openings 14 are sufficiently large to permit the entrance of a targeted pest, and are also sufficiently small to resist the entry of non-targeted organisms that are larger than the targeted pests. The housing 12 further defines an interior upper surface 16 and interior lower surface 18.

A flexible, perforated membrane 20, defining perforations 22 therein, covers a portion of the interior surface of the housing 12, and most preferably covers the interior lower surface 18. The membrane 20 is preferably located generally within the center of the housing 12, a location that resists contact with non-targeted organisms. The perforated membrane 20 has ends 21, 23 which are spaced from ends 25, 26 of tubular housing 12. A poison which will be described in more detail herein is disposed between the flexible membrane 20 and interior lower surface 18.

If the targeted pest is a mouse or a rat, a preferred tubular housing 12 is about 12 to about 24 inches long, and between about 3 inches and about 7 inches in external diameter. An opening 14 that is about 1 inch to about 3 inches in diameter is preferred for rats, and an opening 14 that is about 0.5 inch to about 1 inch in diameter is preferred for mice. The perforations 22 in the flexible membrane 20 are preferably about 1 mm. in diameter and the microcapsules preferably about 0.1 mm in diameter.

The housing 12 may be made from any suitable metal or plastic that is not reactive with the poison. The flexible membrane 20 may also be made from a flexible plastic, or from a thin, flexible metal sheet.

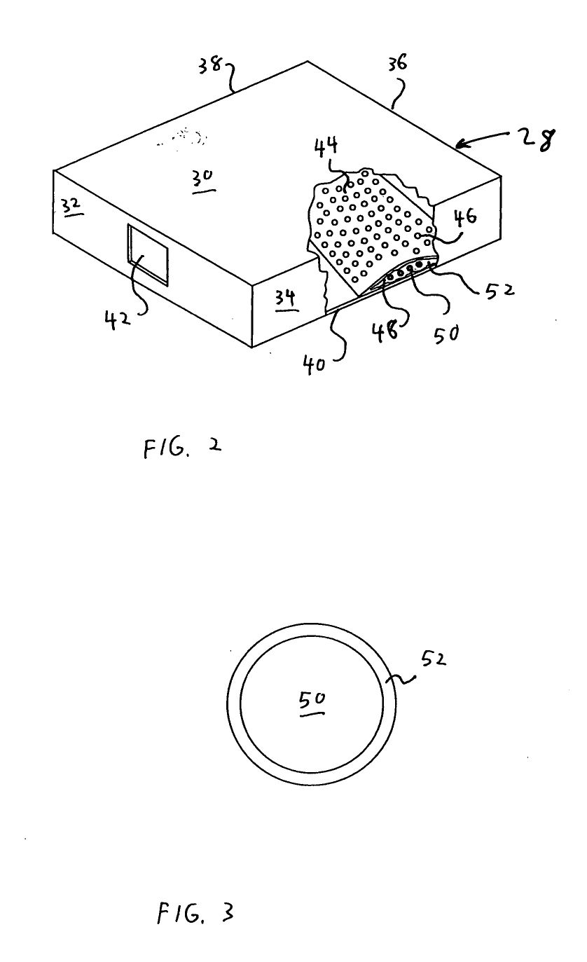

FIG. 2 illustrates another embodiment of the apparatus. The apparatus includes a housing 28 having a box like configuration which in the illustrated example is rectangular in plan. The housing 28 includes a top 30, sides 32, 34, 36, 38, and the bottom 40. The housing 28 further includes at least two openings 42, with each opening 42 defined within one of the sides 32, 34, 36, 38.

A perforated flexible membrane 44 is disposed within the housing 28, against at least one of the interior surfaces of the top 30, sides 32, 34, 36, 38, or bottom 40, with a preferred location being against the bottom 40. The plurality of perforations 46 is defined within the membrane 40. In the form illustrated, a poison 48 is disposed between the membrane 44 and bottom 40. The membrane 44 and poison 48 are preferably located generally centrally within the housing 28, to resist access to the poison 48 by non-targeted organisms, as by through openings 42.

If the targeted pest is a mouse or a rat, the housing 28 may be about 15 inches long by about 15 inches wide by about 4 inches tall. The openings 42 may be about 0.5 inch to about 1 inch wide if the targeted pest is a mouse, or about 1 inch wide to about 3 inches wide if the targeted pest is a rat. The perforations 46 may be about 1 mm. in diameter. The housing 28 may be made from any suitable metal or plastic that will not react with the poison 48. The membrane 44 may be made from any flexible plastic or flexible metal sheet that will not react with the poison 48.

Referring to FIGS. 2 and 3, the poison 48 includes an active ingredient 50 that is microencapsulated within the capsule 52. The active ingredient 50 may be any typical rodenticide (if mice, rats, or other rodents are the targeted pests) or any other chemicals suitable for use against a different targeted pest. Typical rodenticides include brodifacoum, chlorphacinone, diphacinone, cocalciferol, or warfarin. Numerous ways of releasing the poison by causing capsule rupture, as by through enlargement, may be employed. Among the preferred approaches are the following. The encapsulating material may be an acidic or basic hydrogel, which will swell and release the contents of the capsule in response to a change in the surrounding pH. Alternatively, the capsule material may be a hydrogel containing immobilized enzymes, in which case molecules in the solution around the hydrogel capsule enter the capsule where they are enzymatically converted to a product causing the hydrogel capsule to swell and release its contents. The capsule may also be a polyorthoester, which degrades in an acid environment. A capsule made from a thermoresponsive hydrogel will swell and release its contents in response to a temperature change. If the capsule is made from a polyelectrolyte hydrogel, an applied electric field causes the hydrogel capsule to swell and release its contents. A chitosan-based microcapsule will decompose when exposed to an acidic pH. A polypeptide microcapsule will swell when exposed to a basic pH, thereby releasing its contents. Lastly, a liposome based on phospholipid bilayers will, when in contact with a similar lipid-type material, merge with it, thereby releasing its contents into the material with which it merged.

The microcapsules 52 may be suspended within a grease or oil such as petrolatum. The poison 48 may also contain a pheromone or other attractant.

When a targeted pest enters the apparatus 10, 28, it will cross over the membrane 20, 44, thereby causing poison 48 to seep through the perforations 22, 46. The oil or grease 54 will cause the capsules 52 to adhere to the exterior of the targeted pest, for example, the fur of a rodent, until the targeted pest grooms itself, thereby ingesting the poison. The encapsulating material, which up until this point protected the active ingredient 50 from the surrounding environment, is structured to break down after consumption by a targeted pest. The active ingredient is thereby released, killing the targeted pest.

Although the membrane 20 may alternatively be disposed along an upper surface or side surface of the housing 12, the location of the membrane 12 adjacent to a lower surface ensures that a targeted pest will push downward on the membrane 20 as it walks through the housing, ensuring that poison 48 will be dispensed through the perforations 22 within the membrane 20. Additionally, the poison 48 will adhere to the legs and feet of the targeted pest, facilitating grooming to remove and ingest the poison by the targeted pest.

The present invention therefore provides a poison for killing pests that is protected from degradation in the environment where the pest control apparatus is placed. The poison is kept within a location that is difficult for non-targeted organisms to reach, thereby avoiding danger to children or pets. The pest control apparatus does not depend on a food type bait, which is subject to spoilage and/or hoarding by the targeted pests, and which must be replaced frequently. The apparatus takes advantage of the targeted pests natural inclination to seek harborage, and ensures consumption by the targeted pests by taking advantage of the pests natural inclination to groom itself.

It will be appreciated that, if desired, certain preferred enhancements may be employed. For example, if desired, a plurality of housings such as those of FIGS. 1 of 2 may be secured together as by adhesive, straps or other suitable means while preserving independent openings in each for pest entry into each one.

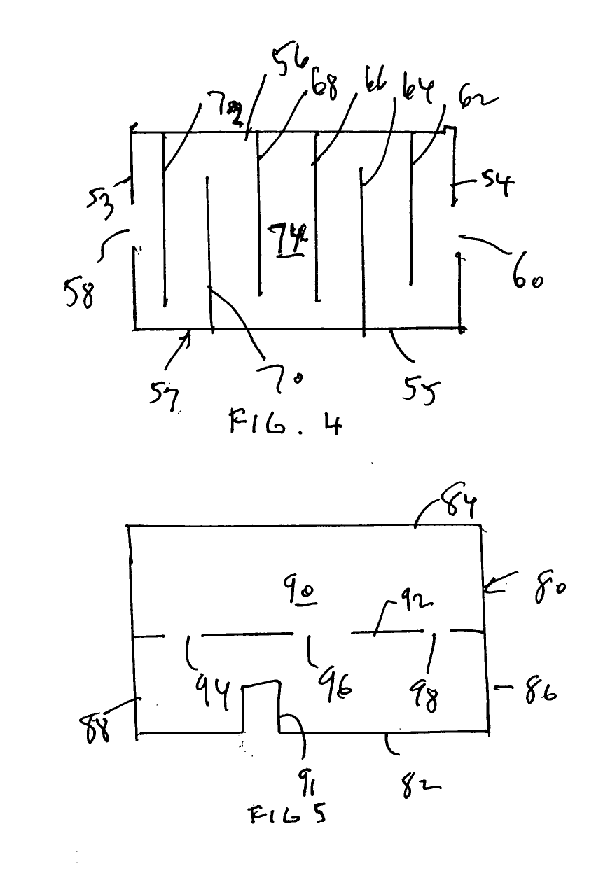

Also, if desired, the chamber may be provided with interior baffles, in order to maximize the extent of pest travel within the chamber. Referring to FIG. 4, there is shown a sectional view taken through a horizontal plane looking down into a chamber which is defined by end walls 53, 54 and side walls 55, 56 and has been identified by the reference number 57. End wall 53 has an exterior access opening 58 and end wall has an exterior access opening 60. A plurality of interior baffles 62, 64, 66, 68, 70 and 72 are shown with each of them being in contact with one of the side walls 55, 56. This will tend to lengthen the path of travel of the pest through the housing 57. It is contemplated that poison will be placed between adjacent pairs of baffles and, if desired, may be placed adjacent each pair of baffles to substantially fill the chamber or the alternative may be in only certain portions thereof. Further, if desired, in chamber subportion 74, a pest attractant may be positioned to further encourage the pest to travel into the interior. All of this serves to maximize the exposure of the pest to the poison, thereby enhancing the likelihood of a substantial number of the microencapsulated poison units will be picked up on the pest's body and ingested during grooming.

If desired, a maze-like structure or multiple room structure may be employed. A pest attractant may be placed in the chamber to lure the pest farther into the interior.

As a further option, the chamber may be vertically arranged to have subcompartments similar to a multistory building with openings therebetween to permit the pest to travel between levels. Poison may be placed on each level. Referring to FIG. 5, there is shown a two-story chamber 80 having a lower wall 82, an upper wall 84 and end walls 86, 88 with rear wall 90 having an exterior access opening 91 and the opposite vertical wall (not shown) provided with a similar opening to permit the pest to enter at the level of lower wall 82. The dividing floor 94 is shown having a plurality of openings 94, 96, 98 through which the rodent may climb to have access to the upper level 92. The openings 94, 96, 98 may be of any desired shape and size, so long as the integrity of floor 94 is preserved to permit placement of poison on both levels 82 and 92.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

1. An apparatus for killing pests, the apparatus comprising:
an exposure chamber having an interior surface;
a flexible membrane covering at least a portion of the interior surface, the flexible membrane having a plurality of perforations therein;
a poison disposed between the flexible membrane and the at least a portion of the interior surface, and
the apparatus being structured so that a target pest passing through the exposure chamber will push on the membrane, thereby pushing poison through the perforations, causing the poison to cling to a surface of the target pest.

2. The apparatus according to claim 1, wherein the membrane is substantially centrally located within the exposure chamber.

3. The apparatus according to claim 1, wherein the exposure chamber is structured to resist access to the poison by humans and animals that are larger than the targeted pest.

4. The apparatus according to claim 1, wherein the exposure chamber is tubular.

5. The apparatus according to claim 4, wherein the tubular body is between about three and about seven inches in external diameter.

6. The apparatus according to claim 4, wherein the tubular body is about 12 to about 24 inches long.

7. The apparatus according to claim 1, wherein the exposure chamber is generally box-shaped.

8. The apparatus according to claim 7, wherein the exposure chamber is about 15 inches long and 15 inches wide.

9. The apparatus according to claim 7, wherein the exposure chamber is about 4 inches tall.

10. The apparatus according to claim 1, further comprising at least two openings defined within the exposure chamber.

11. The apparatus according to claim 10, wherein each of the at least two openings is about 0.5 to 3 inches wide.

12. The apparatus according to claim 1, wherein the poison comprises:
an active ingredient that is microencapsulated, the microcapsules being structured to release the active ingredient upon being ingested by a pest;
a carrier structured to retain the microcapsules in a preselected location and to adhere to an outer surface of a pest.

13. The apparatus according to claim 12, wherein the active ingredient is selected from the group consisting of brodifacoum, chlorphacinone, diphacinone, cocalciferol, and warfarin.

14. The poison according to claim 13, wherein the microcapsules are about 0.1 mm. in diameter.

15. The apparatus according to claim 12, wherein the microcapsule is formed from a member of the group consisting of acidic or basic hydrogel, hydrogel containing immobilized enzymes, polyorthoesters, polyelectrolyte hydrogel, thermoresponsive hydrogel, chitosan-based microcapsules, and polypeptide microcapsules.

16. The apparatus according to claim 12, wherein the carrier is a grease or an oil.

17. The apparatus according to claim 16, wherein the grease or oil is petrolatum.

18. The apparatus of claim 1 including
said chamber having interior baffles.

19. The apparatus of claim 1 including
said chamber having multiple levels with openings therebetween to permit pest travel between said levels.

20. A pest poison apparatus, comprising:
an active ingredient that is microencapsulated, the microcapsules being structured to release the active ingredient upon being ingested by a pest; and
a carrier structured to retain the microcapsules in a preselected location and to adhere to an outer surface of a pest.

21. The poison according to claim 20, wherein the active ingredient is selected from the group consisting of brodifacoum, chlorphacinone, diphacinone, cocalciferol, and warfarin.

22. The poison according to claim 20, wherein the microcapsules are about 0.1 mm. in diameter.

23. The poison according to claim 20, wherein the microcapsule is formed from a member of the group consisting of acidic or basic hydrogel, hydrogel containing immobilized enzymes, polyorthoesters, polyelectrolyte hydrogel, thermoresponsive hydrogel, chitosan-based microcapsules, and polypeptide microcapsules.

24. The poison according to claim 20, wherein the carrier is a grease or an oil.

25. The poison according to claim 24, wherein the grease or oil is petrolatum.

26. A method of killing pests, comprising:
providing an exposure chamber having an interior surface and a perforated membrane covering at least a portion of the interior surface;
providing a poison between a portion of the interior surface and the membrane, the poison having a microencapsulated active ingredient and a carrier for retaining the poison in the desired location;
permitting target pests to enter the exposure chamber while resisting the entry of larger organisms into the exposure chamber; whereby the passage of the target pest into the exposure chamber pushes the membrane towards the interior surface, causing poison to pass through the perforations and adhere to a surface of the pest, thereby causing the pest to ingest poison while grooming itself.

27. The method of claim 26 including
employing said method on rodents.

28. The method of claim 26 including
positioning said membrane generally centrally within said chamber and spaced from exterior openings in the chamber.

29. The method of claim 26 including
employing a chamber which is subdivided by internal baffles.

30. The method of claim 26 including
employing a multilevel chamber with at least two levels having poison disposed thereon.
